(19) United States
(12) Patent Application Publication
(10) Pub. No.: US 2015/0281815 A1
(43) Pub. Date: Oct. 1, 2015

(54) Accessory Shelf

(71) Applicant: Bose Corporation, Framingham, MA (US)

(72) Inventors: Bojan Rip, Newton, MA (US); DonPaul Nogueira, Southborough, MA (US)

(21) Appl. No.: 14/231,318

(22) Filed: Mar. 31, 2014

(51) Int. Cl. H04R 1/02

(52) U.S. Cl. CPC H04R 1/028; H04R 2420/07

(57) ABSTRACT

An accessory shelf for a portable wireless audio system is provided. The accessory shelf may serve as a charging cradle for the portable wireless audio system when in use, and may fold parallel to the wall when not in use. The accessory shelf interacts with the portable wireless audio system to enable audio equalization parameters of the portable wireless audio system to be adjusted automatically upon connection with the accessory shelf to account for the proximity between the portable wireless audio system and a wall adjacent the accessory shelf. One or more wireless communication functions may be incorporated in the accessory shelf to enhance the capabilities of the portable wireless audio system while engaged with the accessory shelf.

### BACKGROUND

This disclosure relates to audio systems and related devices and methods, and, particularly, to an accessory shelf for a portable wireless audio system.

### SUMMARY

All examples and features mentioned below can be combined in any technically possible way.

In one aspect, an accessory shelf includes an input power module, a wireless transceiver to receive wireless communications containing data representing audio signals, a controller to process the received wireless communication and output the audio signals, and contacts for providing the audio signals to a portable wireless audio system coupled to the accessory shelf.

In some implementations, the contacts further provide power to the portable wireless audio system coupled to the accessory shelf.

In certain implementations, the accessory shelf includes a base and a cradle rotatably associated with the base, the cradle being configured to couple with the portable wireless audio system.

In some implementations, the base further includes a plurality of electrical prongs configured to engage a receptacle of a wall outlet to receive power from the wall outlet and to support the accessory shelf adjacent the wall outlet.

In certain implementations, the base further includes at least one stabilizing prong configured to engage a receptacle of a wall outlet to support the accessory shelf adjacent the wall outlet. The stabilizing prong may be a ground prong configured to electrically contact a ground terminal of the receptacle.

In some implementations, the base further includes at least one aperture oriented to align with a center hole of a receptacle unit installed in the wall outlet.

In certain implementations, the base and cradle are configured to enable the cradle to fold approximately parallel to the wall when the portable wireless audio system is not coupled to the accessory shelf.

In some implementations, the cradle is configured to fold flush with the base to not protrude beyond the base when in a vertical storage position.

In certain implementations, the accessory shelf further includes a pass-through electrical outlet and a USB outlet.

In some implementations, the accessory shelf further includes a proximity sensor to detect the presence of a nearby object and output a signal to the controller.

In certain implementations, the controller is configured to process the signal from the proximity sensor and output a signal on the contacts to control an operational state of the portable wireless audio system coupled to the accessory shelf.

In another aspect, an accessory shelf includes an input power module, a controller configured to output a configuration signal to instruct a portable wireless audio system to adjust an audio equalization parameter, and contacts for providing the configuration signal to a portable wireless audio system coupled to the accessory shelf.

In some implementations, the configuration signal instructs the portable wireless audio system to adjust a bass level to account for a proximity between the portable wireless audio system and a wall adjacent the accessory shelf.

In certain implementations, the configuration signal instructs the portable wireless audio system to adjust audio output for a confined environment.

In some implementations, the accessory shelf further includes a proximity sensor to detect the presence of a nearby object and output a signal to the controller.

In certain implementations, the controller is configured to process the signal from the proximity sensor and output a signal on the contacts to control an operational state of the portable wireless audio system coupled to the accessory shelf.

In some implementations, the contacts further provide power to the portable wireless audio system coupled to the accessory shelf.

In another aspect, a system includes a portable wireless audio system and an accessory shelf. The portable wireless audio system includes an audio source, a portable wireless audio system controller to process audio signals from the audio source, an audio subsystem to use audio signals from the controller to produce sound, and at least one portable wireless audio system connection. The accessory shelf includes an accessory shelf controller to process information, and at least one accessory shelf connection to pass instructions from the controller to the portable wireless audio system.

In some implementations, the accessory shelf further includes a wireless transceiver configured to communicate on a wireless network and pass data received over the wireless network to the controller, and the accessory shelf controller is configured to extract audio data from the data received over the wireless network and pass the audio data via the at least one accessory shelf connection to the at least one portable wireless audio system connection of the portable wireless audio system.

In certain implementations, the portable wireless audio system controller is configured to process the audio data received at the at least one portable wireless audio system connection as audio signals and pass the processed audio signal to the audio subsystem to cause the audio subsystem to produce sound.

In some implementations, the accessory shelf controller is configured to generate a first instruction and to output the first instruction on the at least one accessory shelf connection to instruct the portable wireless audio system to adjust how the portable wireless audio system controller processes audio signals from the audio source.

In certain implementations, the accessory shelf controller is configured to generate a second instruction and to output the second instruction on the at least one accessory shelf connection to instruct the portable wireless audio system to turn off.

In some implementations, the accessory shelf further includes a proximity sensor to detect a presence of a nearby object and output a presence signal to the accessory shelf controller, and wherein the accessory shelf controller is configured to generate the second signal in response to the presence signal.

In certain implementations, the accessory shelf controller is configured to generate a third instruction and to output the third instruction on the at least one accessory shelf connection to instruct the portable wireless audio system to adjust a volume of the sound produced by the audio subsystem.

In some implementations, the accessory shelf further includes a proximity sensor to detect a presence of a nearby object and output a presence signal to the accessory shelf controller, and wherein the accessory shelf controller is configured to generate the third signal in response to the presence signal.

In certain implementations, the accessory shelf controller is configured to process the signal from the proximity sensor and output a signal on the accessory shelf contacts to control an operational state of the portable wireless audio system coupled to the accessory shelf.

In some implementations, the at least one accessory shelf connection is further configured to provide power from the accessory shelf to the portable wireless audio device.

### BRIEF DESCRIPTION OF THE DRAWINGS

FIG. 1 is a perspective view of an example accessory shelf.

FIGS. 2A-2F are side views of example accessory shelves.

FIGS. 3A and 3B are front views of the example accessory shelf of FIG. 1.

FIGS. 4A-4D are rear views of an example accessory shelf showing several possible combinations of electrical and stabilizing prongs.

FIG. 5 is a side view of the example accessory shelf of FIG. 1 plugged into a wall outlet and cradling a portable wireless audio system.

FIG. 6 is a functional block diagram of an example accessory shelf and portable wireless audio system.

### DETAILED DESCRIPTION

This disclosure is based, at least in part, on the realization that it is desirable to provide an accessory shelf for a portable wireless audio system. The accessory shelf may serve as a charging cradle for the portable wireless audio system when in use, and may fold parallel to the wall when not in use. The accessory shelf interacts with the portable wireless audio system to enable audio equalization parameters of the portable wireless audio system to be adjusted automatically upon connection with the accessory shelf to account for the proximity between the portable wireless audio system and a wall adjacent the accessory shelf. One or more wireless communication functions may be incorporated in the accessory shelf to enhance the capabilities of the portable wireless audio system while electrically connected to and supported by the accessory shelf.

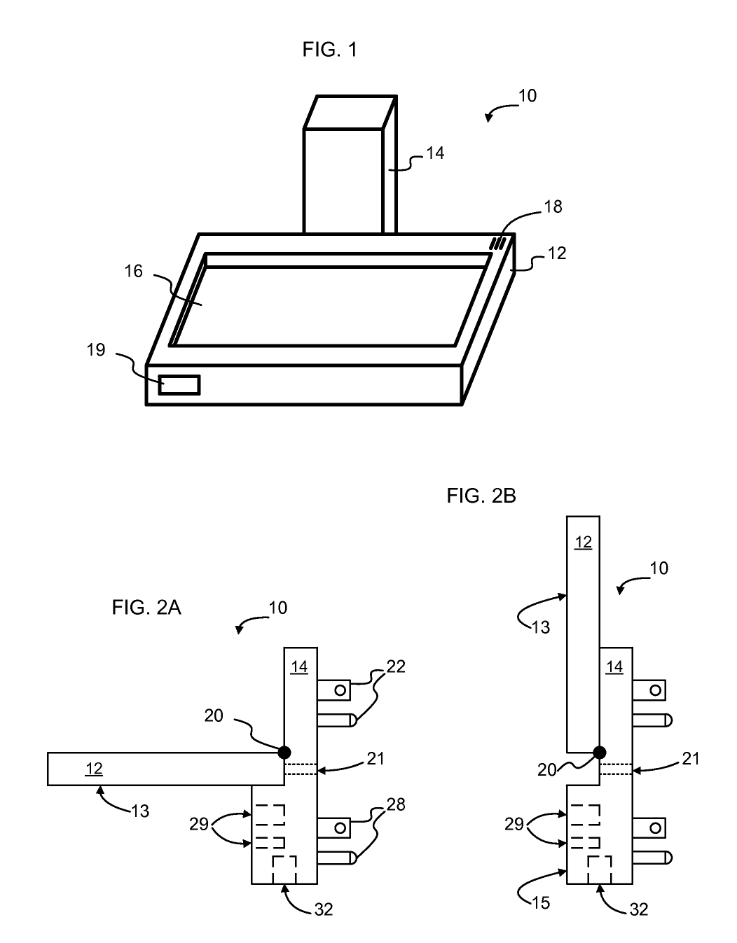

FIG. 1 is a perspective view of an example accessory shelf 10. In the implementation shown in FIG. 1, the accessory shelf 10 includes a cradle 12 and a base 14. The cradle in one implementation has a recessed area 16 to receive a mating bottom profile of a portable wireless audio system. Although an implementation has been shown in which the portable wireless audio system is retained on the cradle 12 using recessed area 16, in other embodiments other mechanisms may be used to prevent the portable wireless audio system from accidentally becoming disengaged from the cradle 12. For example, in an implementation one or more magnets may be provided within the cradle 12 to hold the portable wireless audio system on the cradle.

Power and data connectors 18 are provided to enable the portable wireless audio system to be electrically connected to the cradle when the portable wireless audio system is supported by the accessory shelf 10. Power and data connectors enable power to be provided to the portable wireless audio system so that the portable wireless audio system may be charged while connected to the accessory shelf. An example portable wireless audio system is the SoundLink® Mini Bluetooth® speaker available from Bose®. Other implementations of the accessory shelf 10 may be designed to operate with other types of portable wireless audio systems. Although an implementation is shown in FIG. 1 which includes conductive contacts, other power and data transfer mechanisms such as inductive based energy transfer and capacitive based energy transfer systems may be used as well.

The accessory shelf, in an implementation, also includes a proximity sensor 19 which enables the accessory shelf to receive control input from a user without requiring the user to make physical contact with the accessory shelf, a remote control device, or the portable wireless audio system. A proximity sensor is a sensor that is able to detect the presence of a nearby object without physical contact. An example proximity sensor may emit electromagnetic radiation, e.g., infrared radiation, and watch for changes in a return signal. When the proximity sensor detects a target, it will output a signal to indicate the presence of the target. Many types of proximity sensors have been developed. Different gestures detected by the proximity sensor may be interpreted to cause different actions within the portable wireless audio system.

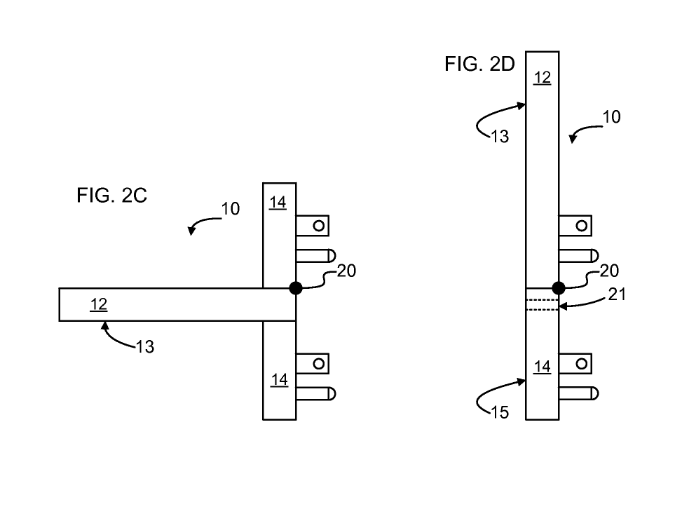

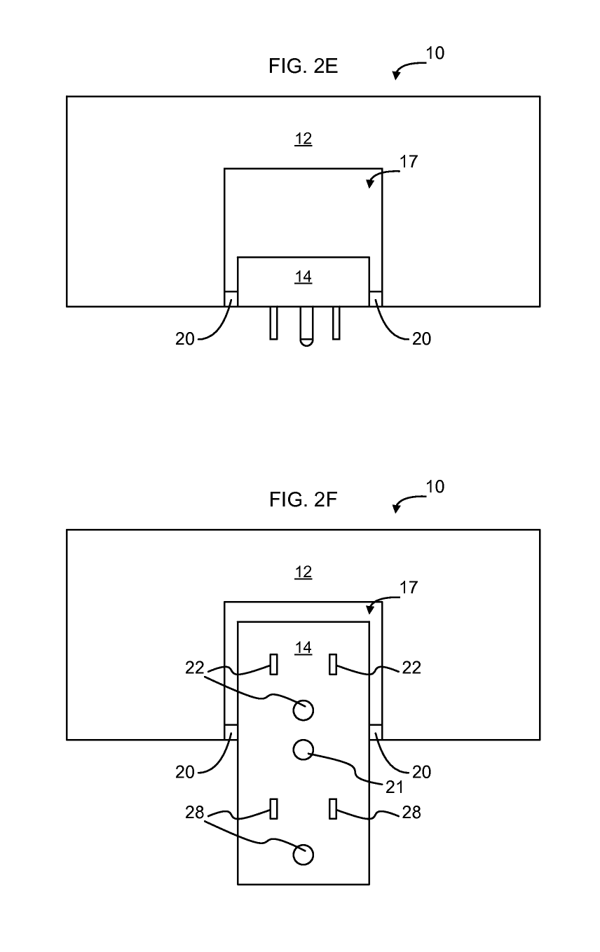

FIGS. 2A-2F show implementations of example accessory shelves from the side. As shown in FIGS. 2A-2B, the accessory shelf 10 is designed such that the cradle 12 can rotate relative to base 14 about pivot 20. This enables the cradle 12 to be folded against base 14 generally parallel to the wall when a portable wireless audio system is not supported by the cradle.

In the implementation shown in FIGS. 2A-2B, the base 14 has a thinner profile above pivot 20 to enable the bottom surface 13 to be folded to be flush with a front surface 15 of base 14 when the cradle is in the folded position.

In another implementation, as shown in FIGS. 2C-2F, the cradle 12 has a recessed region 17 in the proximity of the base 14 and pivot 20 is close to the rear edge of base 14. The recessed region may extend all the way through cradle 12 or may extend sufficiently through cradle to receive the top portion of base 14 when folded into the position shown in FIG. 2D.

FIG. 2E shows a top view of this implementation. As shown in FIG. 2E, the cradle 12 has region 17 adapted to accommodate base 14 when the cradle is moved from the position shown in FIG. 2C to the position shown in FIG. 2D. Specifically, in this implementation, the cradle extends around base 14 and attaches to base 14 at pivot point 20 which is designed to be close to the rear surface of base 14 where base 14 comes into contact with the wall. FIG. 2F shows a rear view of this implementation, in which the cradle has been moved into the folded storage position. As shown in FIG. 2F, region 17 is formed such that, when folded, base 14 fits within region 17. Region 17 may be recessed to accommodate the thickness T of base 14 and may have a solid bottom. In another implementation, region 17 may be cut away. By receiving base 14 within region 17, it is possible to enable the cradle to be folded closer to flush with the wall when in the folded storage position.

The cradle 12 may be biased relative to the cradle, e.g., using a spring, to cause the cradle to fold against the base when not in use. In another implementation a friction hinge may be used to hold the cradle 12 in one of a plurality of positions including the horizontal in-use position shown in FIG. 2A, or the vertical storage position shown in FIG. 2B.

Power and data signals, in one implementation, are provided from the base 14 to the cradle 12 through electrical connections embodied either as part of the hinge 20 or as wires interconnecting the base 14 and cradle 12. In an implementation where the power and data connectors 18 are implemented on the base 14 instead of on the cradle 12, it may be possible to not provide power to the cradle. In this implementation the cradle would function primarily to support the portable wireless audio system and to position the portable wireless audio system to enable the portable wireless audio system to be connected to power and data connectors on the base 14.

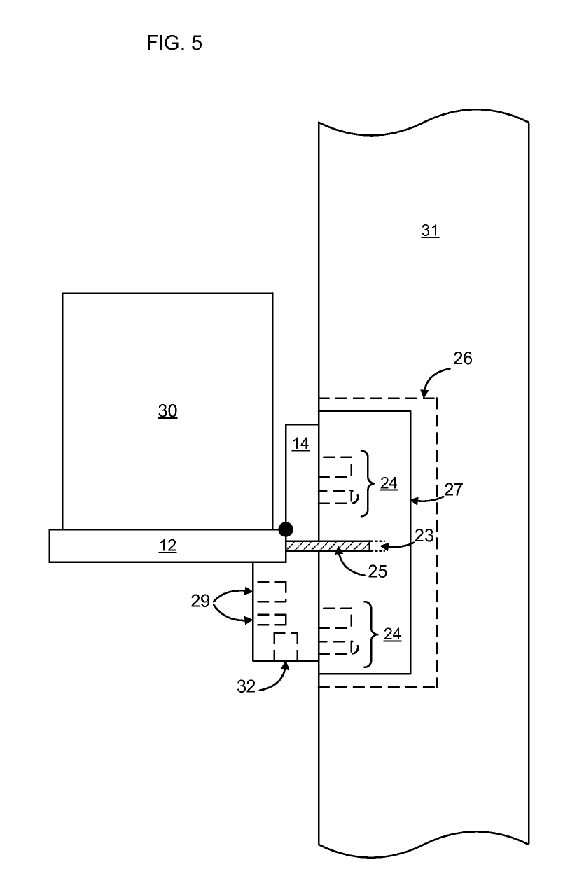

As shown in FIGS. 2A-2B, the base 14 includes at least one set of electrical prongs 22 to enable the accessory shelf to be plugged into a receptacle of a wall outlet and receive power from the wall outlet. The prongs 22 also serve to hold the accessory shelf relative to the wall so that the accessory shelf may be mounted on a wall at a wall outlet (see FIG. 5) without using adhesives, wall anchors, or other mechanical fasteners to anchor the accessory shelf to the wall. In another implementation the accessory shelf is designed to be anchored to the wall and a plug is provided to interconnect the accessory shelf to a wall outlet.

FIG. 5 shows a view of the accessory shelf plugged into a receptacle 24 of a wall outlet 26. Different countries have differently shaped/configured wall outlets and the electrical prongs 22 may be configured accordingly to mate with the intended receptacle configuration. In one embodiment the electrical prongs 22 are interchangeable to enable differently configured electrical prongs to be provided depending on the intended country where the accessory shelf will be used.

In some areas of the United States it is customary to install the wall outlets such that the ground aperture is on the bottom, while in other areas of the country it is customary to install wall outlets such that the ground aperture is on the top. In one implementation the electrical prongs 22 may be rotated 180 degrees to enable the accessory shelf to engage the wall outlet with the cradle 12 facing upwards regardless of the manner in which the receptacle is oriented in the wall outlet. Rotational repositioning of the electrical prongs may require the use of tools, e.g., removal and reinsertion of a screw or other mechanical fastener, so that the electrical prongs are able to be repositioned to match the orientation of the receptacles in the wall outlet.

In the implementation shown in FIGS. 2A-2B, the base also includes a set of stabilizing prongs 28 which are also designed to engage openings of a receptacle of a wall outlet. Conventionally, a receptacle unit in a wall outlet has two receptacles disposed one above the other. By providing one or more stabilizing prongs, which are designed to engage one of the receptacles of a conventional two receptacle unit, the stabilizing prongs may help support the accessory shelf relative to the electrical wall outlet. The stabilizing prongs may be electrically active or may be not electrically active depending on the implementation.

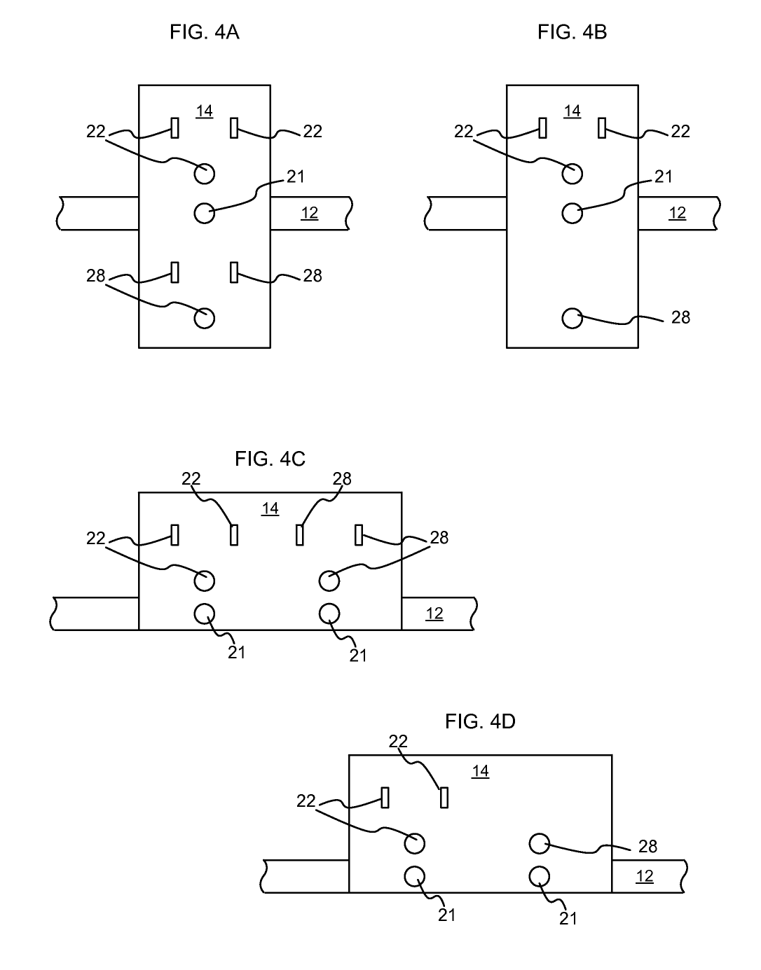

FIGS. 4A-4D show several examples of possible combinations of electrical and stabilizing prongs. In the example shown in FIG. 4A, the energized prongs 22 are provided toward the top of the base 14 and the stabilizing prongs 28 are formed below the energized prongs toward a lower region of the base 14. The relative positions of the energized and stabilizing prongs may be reversed if desired. Additionally, other implementations may not include stabilizing prongs and be designed to only engage one of the electrical receptacles when connected to the electrical wall outlet. Likewise, each of the sets of energized and stabilizing prongs may be rotated 180 degrees to engage receptacles which have been installed into a wall outlet upside down relative to the orientation shown in FIG. 4A.

In the implementation shown in FIG. 4B, like the implementation shown in FIG. 4A, the energized prongs 22 are provided toward the top of the base 14 and the stabilizing prongs 28 are formed below the energized prongs toward a lower region of the base 14. The relative positions of the energized and stabilizing prongs may be reversed if desired. In the implementation shown in FIG. 4B, however, the stabilizing prongs are implemented using only a ground prong which may be electrically active or electrically not active depending on the implementation.

In the implementations shown in FIGS. 4C-4D, rather than having the energized and stabilizing prongs disposed vertically relative to each other, e.g., one above the other, in these implementations the energized and stabilizing prongs are disposed horizontally relative to each other, e.g., side-by-side. FIG. 4C shows an implementation in which three stabilizing prongs are provided and FIG. 4D shows an implementation in which a single (ground) stabilizing prong is provided. In both implementations the energized prongs are on the left when looking at the device from the back. In another implementation the energized prongs may be provided on the right when looking at the device from the back.

Although several configurations have been described, many configurations are possible depending on the implementation.

In an implementation, the base 14 includes aperture 21 configured to receive a bolt to mechanically attach the accessory shelf to the receptacle unit or wall outlet. In an implementation, the aperture is positioned relative to the prongs 22, 28 such that the aperture aligns with a center hole in receptacle unit 27. As shown in FIG. 5, aligning the aperture 21 in accessory shelf with the center hole 23 of receptacle unit 27 in wall outlet box 26 enables a bolt 25 to extend through base 14 and into receptacle unit 27. In an implementation which spans two adjacent receptacle units, such as the implementations shown in FIGS. 4C and 4D, two apertures 21 may be provided. Apertures 21 in this implementation would align with center holes of the two adjacent receptacle units.

Providing aperture 21 enables the accessory shelf to be mechanically connected to the receptacle unit which is installed in outlet wall box 26. The bolt 25 may be sufficiently long to extend through a wall plate covering outlet wall box. Optionally the base 14 may be sized to replace the outlet wall plate such that the wall plate is removed prior to using the bolt 25 to connect the base 14 to receptacle unit 27.

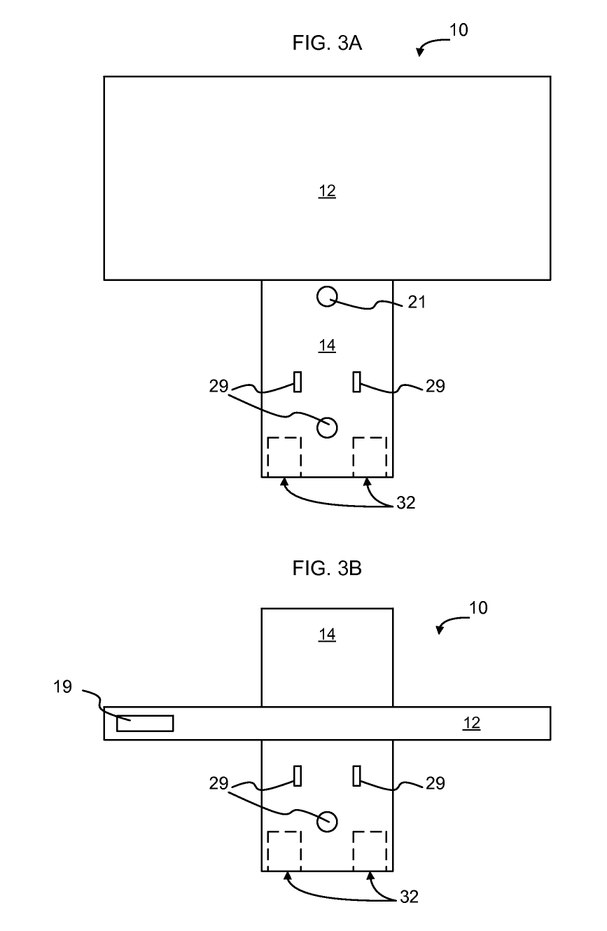

FIGS. 3A-3B show additional views of the implementation shown in FIGS. 1 and 2A-2B. Specifically, FIGS. 3A-3B show the implementation of the accessory shelf from the front in both the storage position (FIG. 3A) and in-use position (FIG. 3B). As shown in FIGS. 3A-3B, the base 14 in this implementation includes one or more outlets such as a pass-through electrical outlet 29 and USB connectors 32. USB connectors enable power to be provided to a device configured to receive power over a USB connection. For example, when a portable wireless audio system is placed on the cradle, other electronic devices that utilize USB charging may be plugged into USB connectors 32 to receive power from accessory shelf. Likewise, if the portable wireless audio system is not on the cradle, a device other than a mating portable wireless audio system may be placed on the accessory shelf and plugged into USB connector 32 to be charged by via the accessory shelf while being held by the cradle. The pass-through outlet 29 is configured similar to the electrical receptacle 24 of wall outlet to enable other utilities to receive electrical power from the wall outlet while the accessory shelf is occupying one or more of the wall outlet receptacles.

FIG. 5 shows a side view of the example accessory shelf 10 plugged into a wall outlet 26 and cradling a portable wireless audio system 30. As shown in FIG. 5, when the portable wireless audio system 30 is placed on the accessory shelf 10, the portable wireless audio system is held relatively close to the wall 31. This is advantageous from a torque standpoint, by limiting the mechanical torque associated with placing the system on a cantilevered shelf extending from the wall outlet. However, placing a wireless audio system in close proximity to a wall will affect the sound quality available from the audio system. For example, amongst other things placing an audio system close to a wall will tend to increase the bass level perceived by a person listening to the audio system.

According to an embodiment, the accessory shelf is designed to interact with the portable wireless audio system to provide electrical charge to the portable wireless audio system and to cause the portable wireless audio system to alter its acoustic equalization while electrically connected to the accessory shelf. Optionally the accessory shelf may also augment the capabilities of the portable wireless audio system, for example by enabling a user to control operation of the portable wireless audio system through interaction with the accessory shelf and/or by providing one or more additional wireless capabilities which the portable wireless audio system does not have.

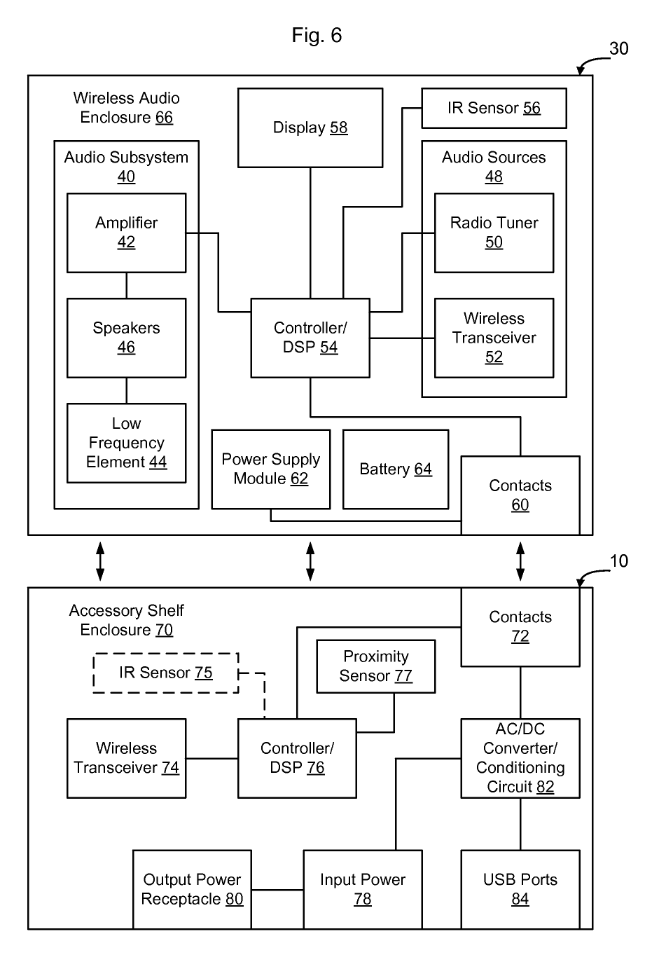

FIG. 6 shows an example functional block diagram of a wireless audio system and accessory shelf according to an implementation. As shown in FIG. 6, portable wireless audio system 30 includes an audio subsystem 40 including an amplifier 42, low frequency element 44 (e.g., an acoustic waveguide, ported box, passive radiators, etc.), and speakers 46.

Portable wireless audio system 30 also includes audio sources 48 including a radio tuner 50 and wireless transceivers 52. Transceiver 52 may include one or more transceivers, such as a WiFi integrated wideband RF transceiver and/or a Bluetooth® low energy transceiver, to enable the portable wireless audio system to communicate using one or more wireless communication protocols. Optionally, not shown, the portable wireless audio system may also have a physical port such as a stereo cable port, network port such as an Ethernet port, USB port, or other connector to enable the portable wireless audio system to receive audio on a physical wired connection.

Radio tuner 50 and wireless transceiver may be connected to suitable antennas to receive wireless signals. Electrical audio signals from radio tuner 50 and wireless transceiver 52 are delivered to controller/DSP 54.

Controller/DSP 54 performs audio signal processing (e.g., equalization, dynamic range compression, tone control, spatial processing, etc.) on the audio signals provided by the audio sources 48 and delivers the processed signals to the audio subsystem 40. In addition, controller/DSP controls the functions of the portable wireless audio system 30. More specifically, remote control commands issued by a user are received at an infrared (IR) sensor 56 and delivered to the controller/DSP to decode and execute.

Controller/DSP 54 also controls what is shown on display 58 if a display is included on the portable wireless audio system. For example, if provided the display 58 may be controlled to display information items such as the current time, current audio source, volume level, etc.

Controller/DSP 54 is also connected to contacts 60 which enable the controller/DSP to determine when the portable wireless audio system is in contact with accessory shelf 10. As discussed herein, when controller/DSP 54 receives a signal via contacts 60 indicating that the portable wireless audio system is in contact with accessory shelf 10, the controller/DSP 54 will adjust the manner in which the controller/DSP performs audio signal processing, (e.g., equalization, dynamic range compression, tone control, spatial processing, etc.) on the audio signals provided to the audio subsystem 40. For example, the DSP may use a different spatial processing profile or may de-emphasize the bass aspects to take into account the fact that the portable wireless audio system is located next to a wall. This enables the processed signals delivered to the audio subsystem 40 to be adjusted such that the audio output by the audio subsystem 40 is tuned to account for the presence of the wall adjacent the portable wireless audio system.

Contacts 60 also include charging contacts for receiving power to provide power to power supply module 62. In one implementation, power supply module 62 passes power to controller/DSP 54 and to the other components of portable wireless audio system 30 to provide power to the portable wireless audio system while turned on and connected to the accessory shelf. Additionally, power supply module 62 provides charge to battery 64. Battery 64 provides power to controller/DSP 54 and to the other components of portable wireless audio system 30 to provide power to the portable wireless audio system while turned on and not otherwise connected to an external power source.

For simplicity, FIG. 5 depicts controller/DSP 54 as a single element, but actual implementations may perform audio signal processing and control functions via separate elements, such as some combination of microprocessors, microcontrollers, or discrete analog components located on one or more circuit boards. Likewise one or more microcontrollers may be used to implement other components of the portable wireless audio system such as to implement the radio transceiver 50 and wireless transceiver 52.

Wireless audio enclosure 66 is provided to contain the components of the portable wireless audio system 10. Accessory shelf 10 likewise has an accessory shelf enclosure 70. In one implementation accessory shelf enclosure 70 has an external surface designed to engage a complimentary surface of wireless audio enclosure 66 to orient the portable wireless audio system 30 while the portable wireless audio system is positioned on the accessory shelf 10. Orientation of the portable wireless audio system with the accessory shelf enables accurate alignment of contacts 60 on portable wireless audio system with corresponding contacts 72 on accessory shelf 10. Referring briefly to FIG. 1, in the implementation shown in FIG. 1, the power and data connectors 18 shown in FIG. 1 correspond to contacts 72 shown in FIG. 6.

Referring again to FIG. 6, in an implementation, accessory shelf 10 includes a wireless transceiver 74. Wireless transceiver 74, in one implementation, is designed to transmit and receive signals in a wireless band/protocol that is not supported by the portable wireless audio system. For example, in one implementation the wireless transceiver 52 of the portable wireless audio system is designed to communicate using Bluetooth® and is not designed to communicate on a WiFi communication network. Wireless transceiver 74, in this implementation, is configured to communicate on a WiFi communication network to receive audio signals via the WiFi communication network. By including a wireless transceiver designed to operate using a communication protocol not supported by the portable wireless audio system, the accessory shelf can augment the wireless networking capabilities of the portable wireless audio system while the portable wireless audio system is connected to the accessory shelf.

In the implementation shown in FIG. 6, data received via wireless transceiver 74 is delivered to the controller/DSP 76. Controller/DSP 76 extracts audio information from the data and optionally performs audio signal processing on the audio signals and delivers the processed signals to the portable wireless audio system via contacts 72.

Within the portable wireless audio system 30, audio signals received via contacts 60 are treated as an audio source such that the signals are processed by controller/DSP 54 and delivered to audio subsystem 40. By implementing a wireless communication protocol not supported by the portable wireless audio system, the accessory shelf 10 is able to enhance the communication capabilities of the portable wireless audio system while the portable wireless audio system is engaged with the accessory shelf.

The accessory shelf 10 also includes an input power module 78 and an output power receptacle 80. Referring briefly to FIGS. 2A, 2B, input power module 78 would be connected to electrical prongs 22 and output power receptacle 80 would correspond to pass-through outlet 29.

Referring again to FIG. 6, accessory shelf 10 also includes AC/DC power converter/conditioning circuit 82 which provides power to contacts 72 to enable the accessory shelf to be used to charge the portable wireless audio system when contacts 60 of the portable wireless audio system are in contact with contacts 72, i.e. when portable wireless audio system is positioned on the accessory shelf. If the accessory shelf includes one or more low power ports, such as one or more USB ports 84, AC/DC converter/conditioning circuit 82 also provides power to the USB ports.

Optionally, USB ports 84 may also serve as an audio source in a manner similar to wireless transceiver 74. In this implementation, when audio signals are received at one of the USB ports 84, the audio signals are delivered to the controller/DSP 76. Controller/DSP 76 optionally performs audio signal processing on the audio signals and delivers the processed signals to the contacts 72. Within the portable wireless audio system 30, audio signals received via contacts 60 are treated as an audio source such that the signals are processed by controller/DSP 54 and delivered to audio subsystem 40.

In an implementation, accessory shelf also includes proximity sensor 77 which enables the accessory shelf to receive input from a user without requiring the user to contact the accessory shelf, remote control, or the portable wireless audio system. Input from proximity sensor 77 is provided to controller/DSP 76. Controller/DSP 76 passes the input to portable wireless audio system 30 via contacts 72. Within portable wireless audio system 30, commands issued by a user and detected by proximity sensor 77 are delivered to controller/DSP 54 to decode and execute. In this manner the user may interact with the accessory shelf to control operation of the portable wireless audio system 30, for example to turn the portable wireless audio system 30 on/off or to control the volume of the portable wireless audio system 30. In an implementation different gestures, detectable by the proximity sensor, may be correlated with different control functions.

Portable wireless audio systems conventionally include a cradle which enables the portable wireless audio system to be charged. Typically the cradle is placed on a counter, desk, table, or other flat surface to enable the portable wireless audio system to be charged so that it is ready for use when required. Use of an accessory shelf to hold a portable wireless audio system may be particularly useful in an environment where counter space or other flat storage space is limited. For example, in a kitchen or bathroom the amount of counter space available to be dedicated to a cradle and portable wireless audio system may be limited. By providing an accessory shelf in this environment the accessory shelf can provide the benefits of a conventional cradle without taking up valuable counter space. Further, as described above, the accessory shelf can also enhance the functionality of the portable wireless audio system by providing communication capabilities not otherwise inherent in the portable wireless audio system.

In some environments, such as in a bathroom environment, the confined nature of the room and/or a large amount of tile or other solid surface may cause the room in which the portable wireless audio system is used to have unique acoustic properties when compared to larger more open spaces. In an implementation, the accessory shelf controller/DSP 76 is able to receive instructions that the environment in which the accessory shelf has been deployed is confined. This instruction may be set once when the accessory shelf is first mounted on the wall outlet. When controller/DSP 76 receives instructions that the accessory shelf is located in a confined environment, it adjusts the signals provided on contacts 72 to instruct controller/DSP 54 to equalize the output audio for a confined environment. As an example, in one implementation the accessory shelf 10 includes an infrared sensor 75 which enables a user to program aspects of how the accessory shelf should interact with the portable wireless audio system when the portable wireless audio system is connected to the accessory shelf.

When controller/DSP 54 receives a confined environment signal via contacts 60 indicating that the portable wireless audio system is located in a confined environment, the controller/DSP 54 will adjust the manner in which the controller/DSP performs audio signal processing, (e.g., equalization, dynamic range compression, tone control, spatial processing, etc.) on the audio signals provided by the audio sources 48 to equalize audio produced by the portable wireless audio system to take into account both that the portable wireless audio system is located next to a wall as well as to take into account that the portable wireless audio system is in a confined environment.

Implementations of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. In addition, the instructions may be implemented in a high-level procedural and/or object-oriented programming language, and/or in assembly/machine language. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other implementations are within the scope of the following claims.

What is claimed is:

1. An accessory shelf, comprising:
an input power module;
a wireless transceiver to receive wireless communications containing data representing audio signals;
a controller to process the received wireless communication and output the audio signals; and
contacts for providing the audio signals to a portable wireless audio system coupled to the accessory shelf.

2. The accessory shelf of claim 1, wherein the contacts further provide power to the portable wireless audio system coupled to the accessory shelf.

3. The accessory shelf of claim 2, further comprising:
a base; and
a cradle rotatably associated with the base, the cradle being configured to couple with the portable wireless audio system.

4. The accessory shelf of claim 3, wherein the base further comprises a plurality of electrical prongs configured to engage a receptacle of a wall outlet to receive power from the wall outlet and to support the accessory shelf adjacent the wall outlet.

5. The accessory shelf of claim 3, wherein the base further comprises at least one stabilizing prong configured to engage a receptacle of a wall outlet to support the accessory shelf adjacent the wall outlet.

6. The accessory shelf of claim 5, wherein the stabilizing prong is a ground prong configured to electrically contact a ground terminal of the receptacle.

7. The accessory shelf of claim 5, wherein the base further comprises at least one aperture oriented to align with a center hole of a receptacle unit installed in the wall outlet.

8. The accessory shelf of claim 3, wherein the base and cradle are configured to enable the cradle to fold approximately parallel to the wall when the portable wireless audio system is not coupled to the accessory shelf.

9. The accessory shelf of claim 8, wherein the cradle is configured to fold flush with the base to not protrude beyond the base when in a vertical storage position.

10. The accessory shelf of claim 1, further comprising a pass-through electrical outlet and a USB outlet.

11. The accessory shelf of claim 1, further comprising a proximity sensor to detect the presence of a nearby object and output a signal to the controller.

12. The accessory shelf of claim 11, wherein the controller is configured to process the signal from the proximity sensor and output a signal on the contacts to control an operational state of the portable wireless audio system coupled to the accessory shelf.

13. An accessory shelf, comprising:
an input power module;
a controller configured to output a configuration signal to instruct a portable wireless audio system to adjust an audio equalization parameter; and
contacts for providing the configuration signal to a portable wireless audio system coupled to the accessory shelf.

14. The accessory shelf of claim 13, wherein the configuration signal instructs the portable wireless audio system to adjust a bass level to account for a proximity between the portable wireless audio system and a wall adjacent the accessory shelf.

15. The accessory shelf of claim 13, wherein the configuration signal instructs the portable wireless audio system to adjust audio output for a confined environment.

16. The accessory shelf of claim 13, further comprising a proximity sensor to detect the presence of a nearby object and output a signal to the controller.

17. The accessory shelf of claim 16, wherein the controller is configured to process the signal from the proximity sensor and output a signal on the contacts to control an operational state of the portable wireless audio system coupled to the accessory shelf.

18. The accessory shelf of claim 13, wherein the contacts further provide power to the portable wireless audio system coupled to the accessory shelf.

19. A system, comprising:
a portable wireless audio system, comprising:
an audio source;
a portable wireless audio system controller to process audio signals from the audio source;
an audio subsystem to use audio signals from the controller to produce sound; and
at least one portable wireless audio system connection; and
an accessory shelf, comprising:
an accessory shelf controller to process information; and
at least one accessory shelf connection to pass instructions from the controller to the portable wireless audio system.

20. The system of claim 19, wherein the accessory shelf further comprises a wireless transceiver configured to communicate on a wireless network and pass data received over the wireless network to the controller; and
wherein the accessory shelf controller is configured to extract audio data from the data received over the wireless network and pass the audio data via the at least one accessory shelf connection to the at least one portable wireless audio system connection of the portable wireless audio system.

21. The system of claim 20, wherein the portable wireless audio system controller is configured to process the audio data received at the at least one portable wireless audio system connection as audio signals and pass the processed audio signal to the audio subsystem to cause the audio subsystem to produce sound.

22. The system of claim 19, wherein the accessory shelf controller is configured to generate a first instruction and to output the first instruction on the at least one accessory shelf connection to instruct the portable wireless audio system to adjust how the portable wireless audio system controller processes audio signals from the audio source.

23. The system of claim 19, wherein the accessory shelf controller is configured to generate a second instruction and to output the second instruction on the at least one accessory shelf connection to instruct the portable wireless audio system to turn off.

24. The system of claim 23, wherein the accessory shelf further comprises a proximity sensor to detect a presence of a nearby object and output a presence signal to the accessory shelf controller, and wherein the accessory shelf controller is configured to generate the second signal in response to the presence signal.

25. The system of claim 19, wherein the accessory shelf controller is configured to generate a third instruction and to output the third instruction on the at least one accessory shelf connection to instruct the portable wireless audio system to adjust a volume of the sound produced by the audio subsystem.

26. The system of claim 25, wherein the accessory shelf further comprises a proximity sensor to detect a presence of a nearby object and output a presence signal to the accessory shelf controller, and wherein the accessory shelf controller is configured to generate the third signal in response to the presence signal.

27. The system of claim 19, wherein the accessory shelf controller is configured to process the signal from the proximity sensor and output a signal on the accessory shelf contacts to control an operational state of the portable wireless audio system coupled to the accessory shelf.

28. The system of claim 19, wherein the at least one accessory shelf connection is further configured to provide power from the accessory shelf to the portable wireless audio device.
